(19) United States
(12) Patent Application Publication
(10) Pub. No.: US 2011/0137880 A1
(43) Pub. Date: Jun. 9, 2011

(54) SYSTEM AND METHOD FOR SEARCHING A DATABASE

(76) Inventor: Daniel BLAIS, Orleans (CA)

(21) Appl. No.: 12/948,219

(22) Filed: Nov. 17, 2010

Related U.S. Application Data
(60) Provisional application No. 61/261,870, filed on Nov. 17, 2009.
(60) Provisional application No. 61/286,424, filed on Dec. 15, 2009.

(51) Int. Cl. G06F 17/30

(52) U.S. Cl. 707/706; 707/769; 707/E17.108

(57) ABSTRACT

A GUI (Graphical User Interface) is used to display items at a user terminal. Each item is user selectable and representative of a search category. A user selects one of the items to generate a query with no other user input required to generate the query. The query includes an identifier of the selected search category and a location identifier. A search for elements associated with the selected category are is performed. A geographical area is defined using the location identifier and a determination is made as to which elements are within the geographical area. The elements that are within the geographical area are then sent to the user terminal. The elements may contain information on establishments such addresses and contact information together with a distance from a central position. In some implementations, the elements are displayed in ascending order of distance of respective establishments from the central position.

### CROSS-REFERENCE TO RELATED APPLICATIONS

This application claims priority to provisional patent application No. 61/261,870 entitled “Method, Process and Apparatus for Searching a Database with One Click of a Visual Icon or Category List” and filed Nov. 17, 2009, and to provisional patent application No. 61/286,424 entitled “Method, Process and Apparatus for Searching a Database with Instant One Click of a Visual Icon or Category List” and filed Dec. 15, 2009.

### FIELD OF THE INVENTION

The invention relates to a system method for searching a databases using a geographic limitation on the search parameters and more particularly to searching for establishments within a defined geographical area.

### BACKGROUND OF THE INVENTION

The Internet is a useful tool wherein users can browse the web to find information on establishments such as businesses, post offices, and schools, for examples. Some search engines provide a geographic locator tool that helps provide users with information on businesses located within a geographical area. However, these tools are not well-suited for quick and easy searching of establishments such as businesses within a geographical area.

For example, U.S. Pat. No. 7,743,048 by Laura J. Baldwin and assigned to Microsoft Corporation discloses a “search near me” and “search near this place option” in which an interface provides a user with the ability to transfer from a general search to a geographic search. However, the Baldwin reference is not well suited for shopping or finding specific categories because it is based on a keyword search that returns all websites within a geographic area containing the keyword(s) used as a search parameter. Furthermore, the user must type the search terms.

U.S. Pat. No. 7,788,252 by Delli Santi et al. and assigned to Yahoo Inc. discloses local intent in a search query. The local intent may reflect whether a search query should receive results and advertisements that are geographically specific. For example, a user may type “Chicago restaurants” and the term “Chicago” may be used as location term and the term “restaurants” may be used as a “root” term for the query. In the Delli Santi et al. reference the user must type the root and location terms.

U.S. patent application Ser. No. 12/207,806 by Deeming et al. and assigned to OUTSIDE.IN, INC. discloses a method and system that provides users with geographic location-specific web content that is targeted to a geographic location specified by a user. The system and method disclosed associates the geographic location specified by the user as a centroid and provides the user with web content that is associated with an area surrounding the centroid. The user specifies the distance by way of text input or via a distance slider on a map illustrating the geographic location.

### SUMMARY OF THE INVENTION

In the present disclosure disclosed is a server system in which a user can access a website and can search for establishments within a geographical area with a single click of a mouse button, or rub or other motion on a surface. A GUI (Graphical User Interface) is displayed for user input. The display includes items/icons each representing a search category. The user launches a search by simply selecting one of the items/icons. The search limits the results to establishments that are within a geographic area which is defined using a location identifier. The location identifier is obtained from a previous search by the user or using the IP (Internet Protocol) Address of the user's terminal for example. Consequently, there is no need for the user to re-enter the location identifier in order to launch a search query. In addition, in some embodiments the geographic area includes a central position and for each element which includes an establishment within the geographic location, the distance between the establishment and the central position is transmitted to the user's terminal along with related information for display. Furthermore, in some implementations the elements are displayed in ascending order of distance of the establishments from the central location.

According to a first broad aspect, the invention provides a method of searching a database. The method involves, at a server system, transmitting information to a terminal of a user for displaying a GUI (Graphical User Interface). The GUI displays a plurality items each representing a respective search category and having associated with it an identifier of the respective search category. The information includes instructions for generating a query in response to a user selection of a selected item of the plurality of items without any other user input. The query includes the identifier of the respective search category of the selected item and a location identifier. The method also involves searching a database to identify elements in the database associated with the identifier of the respective search category of the selected item in response to receiving the query from the terminal. Each element includes information relating to the respective search category of the selected item. The method also involves defining a geographical area using the location identifier; for each identified element, determining whether the identified element is within the geographical area; and, transmitting the identified elements which are within the geographical area to the terminal.

In some embodiments, the geographical area includes a central position and for each identified element the distance between the central position and a position associated with the element is determined. The distance is then transmitted as part of the identified element for display.

In some embodiments, the identified elements which are within the geographical area are each transmitted in at least one packet of data for display as a visual group in order of ascending distance from the central position.

In some embodiments the location identifier includes an IP (Internet Protocol) address.

In some embodiments, the method involves, at the server system, using the IP address to look up a previously used location identifier and using the previously used location identifier to define the geographical area.

In some embodiments, the method involves determining location information using the IP address and defining the geographical area using the location information.

In some embodiments, at least one of the search categories comprises at least one of a name of an establishment, business category, and business sub-category.

In some embodiments, the location identifier comprises one of a postal code, city, town, a metropolitan center, a subdivision, and a suburb.

In accordance with a second broad aspect, the invention provides a server system for searching a database. The server system has a communications interface for receiving and transmitting data across a network and an interface unit coupled to communications interface for transmitting information to a terminal of a user for displaying a GUI (Graphical User Interface). The GUI is used to display a plurality of items each representing a respective search category and having associated with it an identifier of the respective search category. The information includes instructions for generating a query in response to a user selection of a selected item of the plurality of items without any other user input. The query includes the identifier of the respective search category of the selected item and a location identifier. The server system also has a database that includes elements each associated with a search category and a search engine for searching the database in response to receiving the query from the terminal to identify elements in the database which are associated with the identifier of the respective search category of the selected item. The search engine has a geographical search unit coupled to the communications interface for defining a geographical area using the location identifier; for each identified element, determining whether the identified element is within the geographical area; and, transmitting the identified elements which are within the geographical area to the terminal.

In accordance with a third broad aspect, the invention provides a method of searching a database. The method involves, at a user terminal, displaying a GUI (Graphical User Interface) having a plurality items each representing a respective search category and having associated with it an identifier of the respective search category. Responsive to a user selection of an item of the plurality of items, a query is generated without any additional user input. The query includes the identifier of the respective search category of the selected item and a location identifier. The method also involves searching a database to identify elements in the database associated with the identifier of the respective search category of the selected item with each element including information relating to the respective search category of the selected item; defining a geographical area using the location identifier; for each identified element, determining whether the identified element is within the geographical area; and, transmitting the identified elements which are within the geographical area to the terminal.

In some embodiments, the method involves retrieving the location identifier from memory at the user terminal.

In some embodiments, the location identifier includes an IP address the location identifier is used to retrieve another location identifier from memory. The other location identifier is then used to define the geographic area.

### BRIEF DESCRIPTION OF THE DRAWINGS

The features and advantages of the invention will become more apparent from the following detailed description of the preferred embodiment(s) with reference to the attached figures, wherein:

FIG. 1 is a schematic block diagram illustrating a network system of computing elements for providing one-click access to geographical information defined within a geographical area, according to a preferred embodiment of the invention;

FIG. 2A is a GUI (Graphical User Interface) being displayed at a terminal of a user on the network system of FIG. 1;

FIG. 2B is display of results from a database search displayed on the terminal of the user on the network system of FIG. 1 after the user has selected a search category using a one-click process;

FIG. 3 is a functional block diagram of a server system of FIG. 1; and,

FIG. 4 is flow chart of the steps followed by the server system of FIG. 3 in providing one-click access to geographical information defined within a geographical area.

### DETAILED DESCRIPTION OF THE PREFERRED EMBODIMENTS

As discussed in the Background of the Invention section, the Prior Art solutions are not well-suited for quick and easy searching of establishments such as businesses within a geographical area. Particularly, in the prior art solutions a user must type in search parameters and provide location information before a geographical based search can be performed. In the present disclosure disclosed is a server system in which a user can access a website and can search for establishments within a geographical area with a single click of a mouse button, or rub or other motion on a surface. The results of the search are displayed containing information on the establishments within the geographical area.

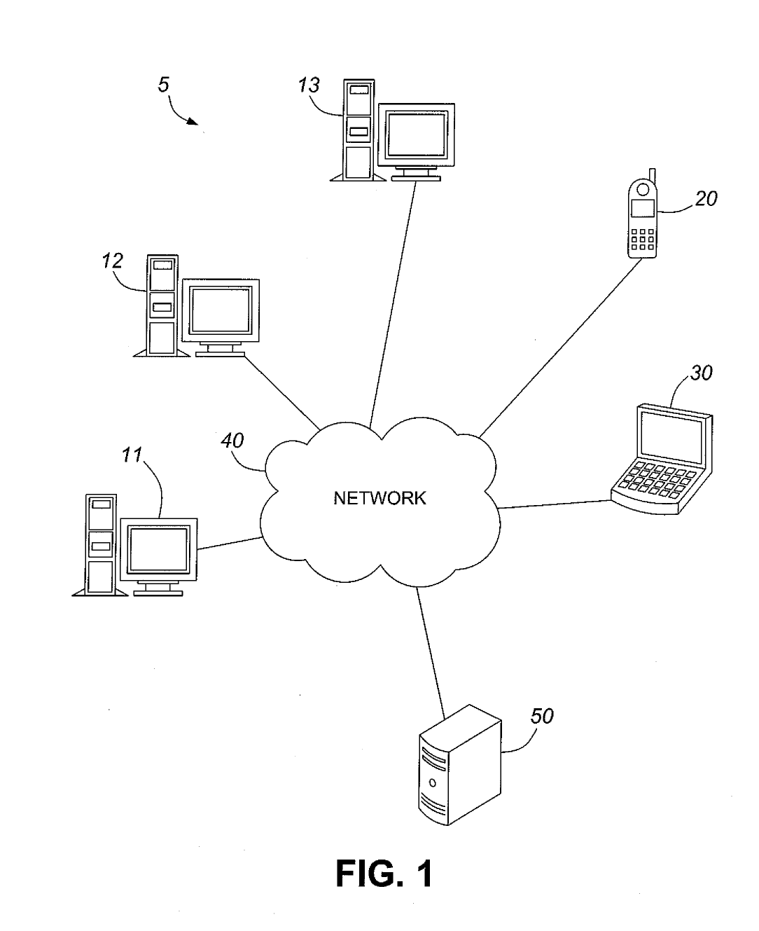

Referring to FIG. 1 shown is a schematic block diagram illustrating a network system of computing elements, generally indicated by 5, for providing one-click access to geographical information defined within a geographical area; according to a preferred embodiment of the invention. The network system has terminals, such as PCs (Personal Computers) 11, 12, 13, mobile device 20, and laptop 20, coupled together for communication over a network 40. The network 40 is any suitable network for communications between terminals and can include the Internet, for example. The terminals may be any computer, mobile device, or any other device that has access to the Internet.

A server system 50 is also coupled to the network 40 for communication with the PCs 11, 12, 13, the mobile device 20, and the laptop 20.

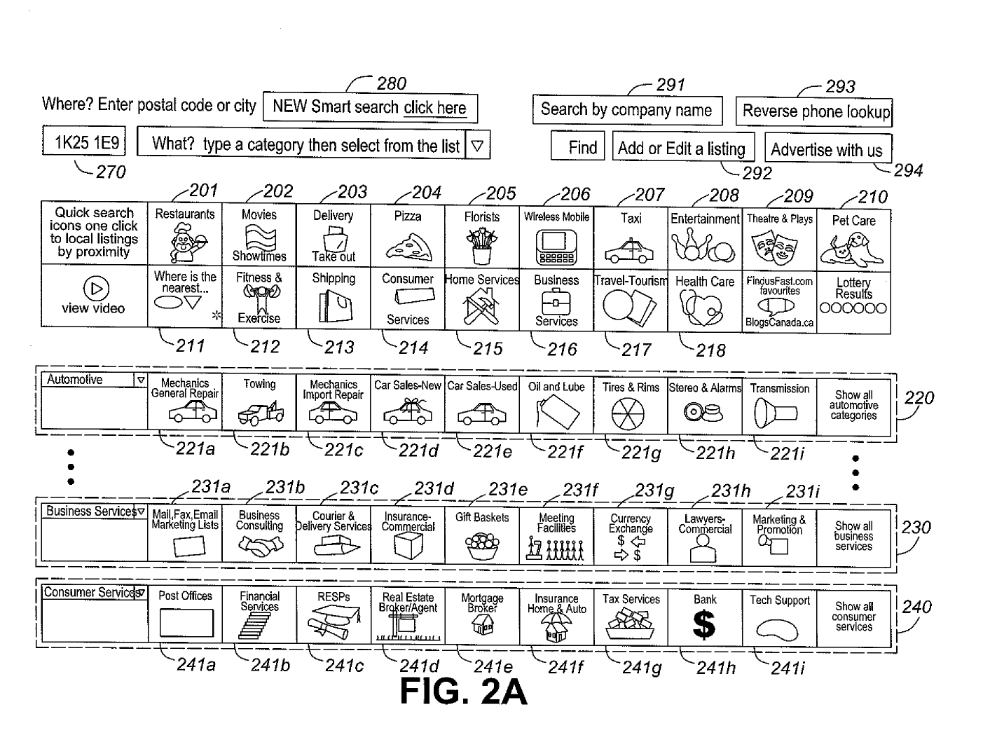

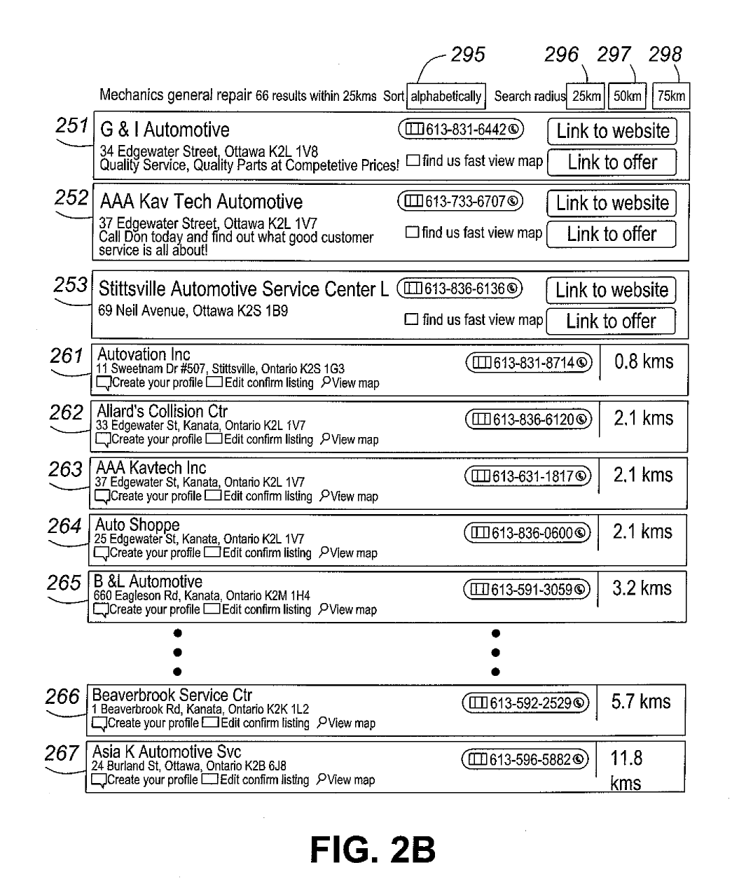

In an exemplary implementation a user at the PC 11 accesses the server system 50 using a web browser, for example. The server system 50 provides the user at the PC 11 with a GUI (Graphical User Interface) that allows the user to initiate a search for information on establishments that are located in the vicinity of a geographical location. An example GUI, generally indicated by 200, is shown in FIG. 2A. The GUI 200 includes a icons 201, 202, 203, 204, 205, 206, 207, 208, 209, 210, 211, 212, 213, 214, 215, 216, 217, 218, 221a, 221b, 221c, 221d, 221e, 221f, 221g, 221h, 221i, 231a, 231b, 231c, 231d, 231e, 231f, 231g, 231h, 231i, 241a, 241b, 241c, 241d, 241; 241f, 241g, 241h, 241i, each representing a respective search category. For example, the icon 202 represents a search for movies and show times, whereas the icon 241a represents a search for post offices. The icons 221a, 221b, 221c, 221d, 221e, 221f, 221g, 221h, 221i are grouped into an automotive super category for ease in navigating the GUI 200. In addition, the icons 231a, 231b, 231c, 231d, 231e, 231f, 231g, 231h, 231i are grouped into a business service super category 230 and the icons 241a, 241b, 241c, 241d, 241e, 241f, 241g, 241h, 241i are grouped into a consumer services super category 240.

Displayed in a user input window 270 is the user's postal code. The postal code provides a location identifier for the search. In this example the user has previously performed a search for establishments under a specific category in the vicinity of the postal code corresponding to K2S 1E9. This postal code is being displayed automatically as a default location identifier for the next search to allow the user to initiate a further search for establishments in the vicinity of the postal code K2S 1E9 under the same or different category by simply selecting a respective icon.

For example, the user can initiate a search for Mechanic for general car repair in the vicinity of the K2S 1E9 postal code by simply selecting the icon 221a. FIG. 2B shows the results of a database search being displayed on the terminal of the user on the network system of FIG. 1 after the user has selected the icon 221a. The results from the search include elements 251, 252, 253, 261, 262, 263, 264, 265, 266, 267 each containing address and contact information on an establishment, a link to the establishment's website, and distance from a central position. The results are obtained from a search under the Mechanic for general car repair category and include only those elements 251, 252, 253, 261, 262, 263, 264, 265, 266, 267 whose establishments are within a 25 km radius of the postal code. In other implementations additional information such as links to maps of establishments and links to directions from the provided postal code to the establishments is also displayed. For each element 261, 262, 263, 264, 265, 266, 267, the distance from the respective establishment and a location associated with the postal code is also displayed. Particularly, elements 251, 252, 253 are preferred clients of a provider the search service and these elements displayed first. The elements 261, 262, 263, 264, 265, 266, 267 are displayed in ascending order of distance from the location defined by the postal code.

In this example implementation the elements 261, 262, 263, 264, 265, 266, 267 are displayed by default in ascending order of distance from the location defined by the postal code search. However, the user can select to have the result displayed in alphabetical order by selecting item 295. In addition, in the example implementation the search results are shown for establishments that are within a default radius of 25 km from the location associated with the postal code. In the display of FIG. 2B the user can select a particular radius of search by selecting one of items 296, 297, 298. The selection of any one of the items 296, 297, 298 initiates a further search under the same category but now with a user specified radius.

Referring back to FIG. 2A, the user can also change the postal code to change the location identifier for determining a new geographical search area before submitting a new search. In addition, the GUI 5 includes a user input window 280 in which the user can type a category to be searched or the name of a business or other establishment to be searched. The user input window also provides a drop-down menu from which the user can select a category for searching.

The GUI 5 also has other user selectable items for performing other types of searches. Item 291 can be selected for performing a search by company name or more generally by a name of an establishment. Item 292 can be selected by a user associated with a particular establishment for adding or editing listings or elements to be searched. Item 293 can be selected for performing reverse phone lookups and item 294 can be selected to subscribe to advertising services provided by the service provider.

The disclosure above describes many ways for selecting a category or a sub-category of larger category, such as restaurants and florists under a business category for example.

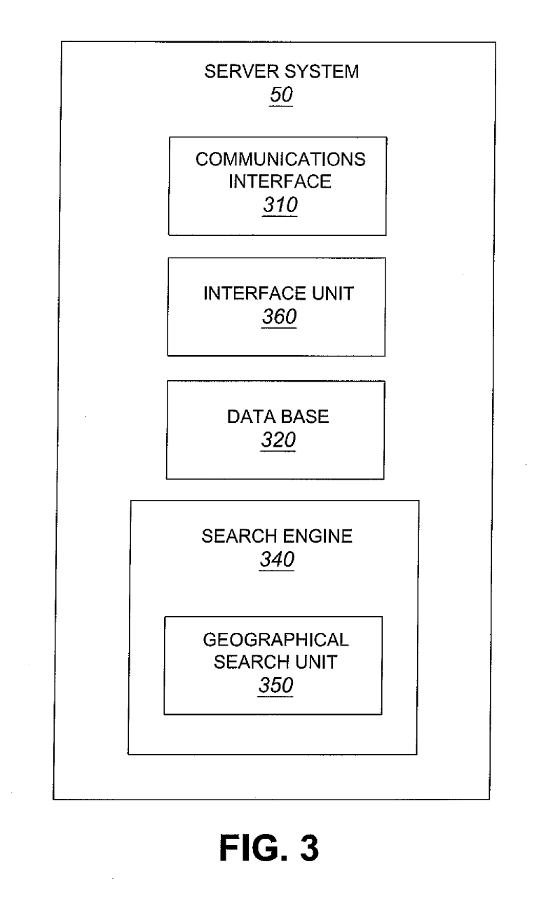

The server system of FIG. 1 will now be described in more detail with reference to FIG. 3. In FIG. 3, the server system 50 is shown having a communications interface 310, a database 320, a search engine 340, and an interface unit 360. The search engine includes a geographical search unit 350.

The communications interface 310 receives from and transmits to terminals information across a network. The interface unit 360 makes use of the communications interface 310 for transmitting information to a terminal of a user for displaying a GUI for initiating a search by the user. The database 320 includes elements each associated with a search category. The search engine 340 is used to search the database 320 for information on establishments within a selected search category. The geographical search unit 350 is used to determine which establishments are within a geographical area and transmit the search results to the terminal of the user.

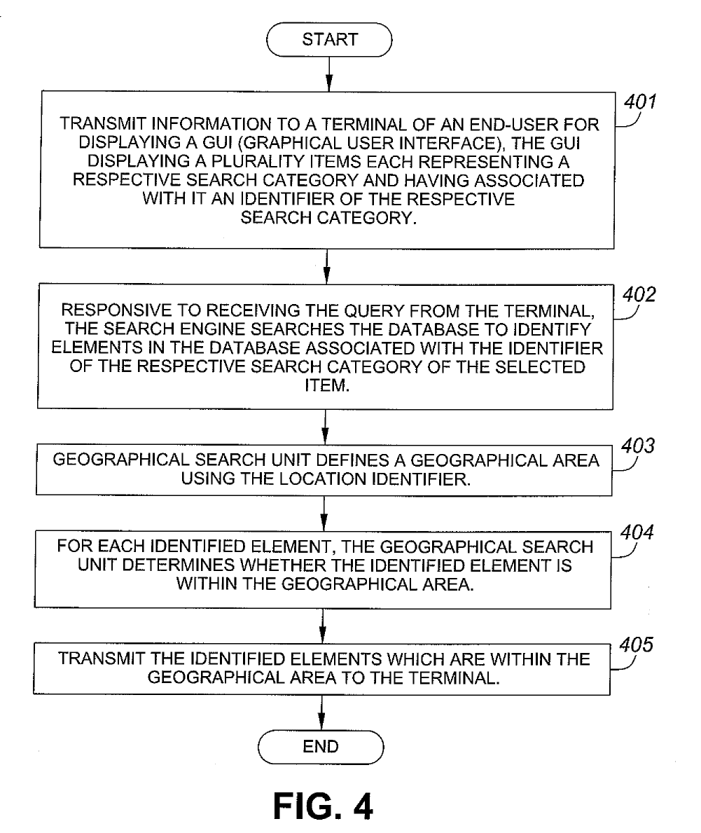

Further details of how the server system of FIG. 3 can be used to provide a one-click user experience for performing a search within a geographical area will now be described with reference to FIG. 4.

FIG. 4 is flow chart of the steps followed by the server system 50 of FIG. 3 in providing a one-click access to geographical information defined within a geographical area. At step 401, the interface unit 360 makes use of the communications interface 310 to transmit information to a terminal of a user for displaying a GUI. The GUI, an example of which is shown as GUI 5 in FIG. 2A, is used to display a plurality items each representing a respective search category and having associated with it an identifier of the respective search category. The information being transmitted includes instructions for generating a query in response to a user selection of a selected item without the need of any other user input. The query includes the identifier of the respective search category associated with the selected item and a location identifier.

At step 402 responsive to receiving the query from the terminal, the search engine 340 searches the database 320 to identify elements in the database associated with the identifier of the respective search category of the selected item. As discussed above, each element includes information relating to the respective search category of the selected item. For example, each element includes information on a particular establishment such as phone number, address, name of business, for example, and any other information that may be useful to a user.

At step 403 the geographical search unit 350 defines a geographical using the location identifier. There are a number of way in which the geographical area can be defined. In one implementation the geographical search unit 350 defines the geographical area as a circular area of a default radius about a central location defined by the location identifier. The location identifier is any suitable location identifier from which a geographic position can be obtained. For example, the location identifier may be a postal code or zip code. Alternatively, the location identifier is a town or city name, suburb or subdivision from which a central position of the town, city name, suburb or subdivision is determined. In some implementations when a user searches by city or town, a link is provided to locate a postal code corresponding to the city or town. Furthermore, large metropolitan centers may be divided into user-friendly sections in terms of location such as central, east, west, north, south, division and/or suburb for example.

At step 404 for each identified element the geographical search unit 350 determines whether the identified element is within the geographical area, and at step 405 the geographical search unit 350 makes use of the communications interface for transmitting the identified elements which are within the geographical area to the terminal for display.

With reference back to step 401, the location identifier that is sent as part of the query can be any suitable identifier of a geographic location or even a geographic position such as longitude and latitude coordinates for example. In some implementations the location identifier is an IP (Internet Protocol) address of the user's terminal. In such implementations, the location identifier is used by the geographical search unit 350 to determine a location associated with the user's terminal. Tools for determining geographical location based on an IP address are well-known in the art.

Alternatively, in other cases or implementations the location identifier is a town or city name, suburb or subdivision from which a central position can be determined and this location identifier is included in the query. There are a number of ways in which the location identifier can be sent as part of the query without having to enter the location identifier just prior selecting a category to search. For example, the user may have previously accessed a website for accessing the search capabilities of the server system and performed a search by entering a location identifier. In such a case, the interface unit 360 provides instructions to the user terminal for storing in memory as part of a cookie the location identifier entered by the user. The location identifier can then be retrieved for later use. When the user later accesses the website to perform another search, the GUI provided by the server system 50 to the user terminal includes instructions for retrieving the location identifier from the cookie and transmitting the location identifier as part of the query.

In other implementations, the geographical search unit 350 stores locally a location identifier provided by the user for later use. The next time the user's terminal accesses the server system 50 the geographical search unit 350 retrieves the stored location identifier using the IP address and/or other parameters for identifying the user's a geographic location of the user's terminal and defines geographical search area using the retrieved location identifier. Furthermore the server system 50 transmits the stored location identifier the user's terminal for display as a default location identifier.

Referring back to steps 403, 404 of FIG. 4, in some implementations the geographical area is defined as a circular area of a particular radius. In such implementations whether an element is within the geographical area is determined by determining the distance between the position of an establishment associated with the element and a position associated with the location identifier. For example, the location identifier received from the user's terminal may include a postal code, and the geographical search unit 350 looks up a table of entries (not shown) for extracting a central position of the geographical area. Similarly, the element of the database includes a postal code for the establishment and the geographical search unit 350 looks up the table of entries to extract the position of the establishment. The distance between the central position and the position of the establishment is then determined and if the distance is less than the radius of the geographical area the establishment is within the geographical area; otherwise, it falls outside the geographical area. The positions are defined using longitude and latitude coordinates for example.

In other implementations, the geographical area is defined by other means than a central position and a radius. For example, in some implementations the location identifier is a postal code and the geographical area is defined by the area covered by the postal code and areas covered by those postal codes adjacent to that of the location identifier. Any element having a postal code corresponding to any one of the postal codes within the defined geographical area is selected for display to the user.

In some implementations the information associated with each element is organized into one or more packets of data for display as a visual group. For example, with reference to FIG. 2B, for each element the packets of data define a respective one of items 251, 252, 253, 261, 262, 263, 264, 265, 266, 267 as a visual group. As discussed above, in some implementations the geographical area has a central position and that step 404 for each identified element the distance between an establishment and the central position is determined. At step 405 the identified elements which are within the geographical area are transmitted to the user's terminal for display as visual groups in ascending order of distance from the central position.

The embodiments presented are exemplary only and persons skilled in the art would appreciate that variations to the embodiments described above may be made without departing from the spirit of the invention. The scope of the invention is solely defined by the appended claims.

I/We claim:

1. A method of searching a database, the method comprising, at a server system:
transmitting information to a terminal of a user for displaying a GUI (Graphical User Interface), the GUI displaying a plurality items each representing a respective search category and having associated with it an identifier of the respective search category, the information comprising instructions for generating a query in response to a user selection of a selected item of the plurality of items without any other user input, the query including the identifier of the respective search category of the selected item and a location identifier;
responsive to receiving the query from the terminal, searching a database to identify elements in the database associated with the identifier of the respective search category of the selected item, each element comprising information relating to the respective search category of the selected item;
defining a geographical area using the location identifier;
for each identified element, determining whether the identified element is within the geographical area; and,
transmitting the identified elements which are within the geographical area to the terminal.

2. A method according to claim 1 wherein the geographical area comprises a central position and for each identified element, the determining whether the identified element is within the geographical area comprising determining the distance between the central position and a position associated with the element, the distance being transmitted to the terminal as part of the identified element for display.

3. A method according to claim 2 wherein the identified elements which are within the geographical area are each transmitted in at least one packet of data for display as a visual group in order of ascending distance from the central position.

4. A method according to claim 1 wherein the location identifier comprises an IP (Internet Protocol) address.

5. A method according to claim 4 wherein the defining a geographical area using the location identifier comprises:
at the server system, using the IP address to look up a previously used location identifier and using the previously used location identifier to the define geographical area.

6. A method according to claim 4 wherein the defining a geographical area using the location identifier comprises determining location information using the IP address and defining the geographical area using the location information.

7. A method according to claim 1 wherein the geographic area is defined as a circular area of a predetermined radius about a central geographic position defined by the location identifier and wherein for each element in the database the information relating to the respective search category of the selected item comprises a geographic position of a respective establishment, and
wherein for each identified element, the determining whether the identified element is within the geographical area comprises determining the distance between the central geographic position defined by the location identifier and the geographic position of the respective establishment.

8. A method according to claim 7 comprising:
for each identified element that is within the geographical area, transmitting to the terminal the distance between the central geographic position defined by the location identifier and the geographic position of the respective establishment.

9. A method according to claim 8 comprising transmitting instructions for displaying the identified elements which are within the geographical area to the terminal in ascending order of distance from the central geographic position.

10. A method according to claim 1 wherein the search categories comprise at least one of a name of an establishment, business category, and business sub-category.

11. A method according to claim 1 wherein the location identifier comprises one of a postal code, city, town, a metropolitan center, a subdivision, and a suburb.

12. A server system for searching a database, the server system comprising:
a communications interface for receiving and transmitting data across a network;
an interface unit coupled to communications interface for transmitting information to a terminal of a user for displaying a GUI (Graphical User Interface), the GUI displaying a plurality of items each representing a respective search category and having associated with it an identifier of the respective search category, the information comprising instructions for generating a query upon a user selection of a selected item of the plurality of items without any other user input, the query including the identifier of the respective search category of the selected item and a location identifier;
a database comprising elements each associated with a search category;
a search engine for searching the database in response to receiving the query from the terminal to identify elements in the database which are associated with the identifier of the respective search category of the selected item, the search engine comprising:
a geographical search unit coupled to the communications interface for:
defining a geographical area using the location identifier;
for each identified element, determining whether the identified element is within the geographical area; and,
transmitting the identified elements which are within the geographical area to the terminal.

13. A method according to claim 12 wherein the geographical area comprises a central position and for each identified element, the geographical search unit determining the distance between the central position and a position associated with the element and transmitting said distance to the terminal as part of the identified element for display.

14. A method according to claim 13 wherein the identified elements which are within the geographical area are each transmitted in at least one packet of data for display as a visual group in order of ascending distance from the central position.

15. A method according to claim 12 wherein the location identifier comprises an IP (Internet Protocol) address.

16. A method according to claim 12 wherein the search categories comprises at least one of a name of an establishment, business category, and business sub-category.

17. A method according to claim 12 wherein the location identifier comprises one of a postal code, city, town, a metropolitan center, a subdivision, and a suburb.

18. A method of searching a database, the method comprising:
at a user terminal, displaying a GUI (Graphical User Interface) having a plurality items each representing a respective search category and having associated with it an identifier of the respective search category;
responsive to a user selection of an item of the plurality of items, generating a query without any additional user input, the query including the identifier of the respective search category of the selected item and a location identifier;
searching a database to identify elements in the database associated with the identifier of the respective search category of the selected item, each element comprising information relating to the respective search category of the selected item;
defining a geographical area using the location identifier;
for each identified element, determining whether the identified element is within the geographical area; and,
transmitting the identified elements which are within the geographical area to the terminal.

19. A method according to claim 18 comprising retrieving the location identifier from memory at the user terminal.

20. A method according to claim 18 wherein the location identifier comprises an IP (Internet Protocol) address, the defining a geographical area using the location identifier comprising retrieving an other location identifier from memory and using the other location identifier to define the geographic area.

21. A method according to claim 18 wherein the geographical area comprises a central position and for each identified element, the determining whether the identified element is within the geographical area comprising determining the distance between the central position and a position associated with the element, the distance being transmitted terminal as part of the identified element for display.

22. A method according to claim 21 wherein the identified elements which are within the geographical area are each transmitted in at least one packet of data for display as a visual group in order of ascending distance from the central position.
